(19) United States
(12) Patent Application Publication
(10) Pub. No.: US 2006/0242937 A1
(43) Pub. Date: Nov. 2, 2006

(54) Crop take-up assembly and harvesting machine

(76) Inventors: Jeremy Pourchet, Gilley (FR); Etienne Josset, Arc les Gray (FR)

Correspondence Address: DEERE & COMPANY, ONE JOHN DEERE PLACE, MOLINE, IL, 61265, US

(21) Appl. No.: 11/408,395

(22) Filed: Apr. 20, 2006

(30) Foreign Application Priority Data
Apr. 29, 2005 (DE) 10 2005 020 463.5

(51) Int. Cl. A01D 57/00

(52) U.S. Cl. 56/219

(57) ABSTRACT

A crop take-up assembly having a rotatable take-up rotor with tines mounted thereon. A first guide assembly encloses the tines in an upper, forward and lower region, and defines a first set of guide tracks in which the tines are guided along a curved path. A second guide assembly encloses the tines in a rear region. The second guide assembly guides the tines into the first set of guide tracks during a reversal of rotation of the take-up rotor.

1. Field of the Invention

The invention relates to a crop take-up assembly having a take-up rotor equipped with tines.

2. Background of the Invention

Known crop take-up assemblies are provided with a take-up rotor having an overrunning clutch so that it does not reverse in the event of a reversal of the crop take-up assembly. Otherwise, this could lead to an interlocking of the tines of the take-up rotor. Not having the ability to reverse this makes it difficult to move obstructions in the area of the take-up rotor of such assemblies.

In view of the above limitations and drawbacks, there is a need for a crop take-up assembly which will allow easier removal of obstructions in the area of the take-up rotor.

### SUMMARY

The invention proposes a crop take-up assembly with a take-up rotor that is provided with tines and a first guide assembly enclosing the tines in an upper, forward and lower region. The first guide assembly defines guide tracks, wherein the tines are guided along a curved path during normal operation. According to the present invention, a second guide assembly is provided in a region to the rear of the direction of conveying. The second guide assembly guides the tines in the direction of the guide tracks during a reversal of the take-up rotor. In this way the take-up rotor can also be reversed or moved in a direction opposite to the normal conveying direction, for removal of an obstruction for example, or to eject metallic objects or stones, without causing the tines to interlock as a result of misalignment with the first guide tracks. The first and second guide assemblies are preferably configured as multi-piece components, however, a one-piece configuration is also conceivable.

In another aspect, the second guide assembly is provided with its own guide tracks, wherein the tines are guided, particularly in the case of a reversal of the take-up rotor, within the guide tracks.

In still another aspect, the guide tracks may be bordered by guide surfaces to reduce the possibility of an obstruction. The guide surfaces can be bordered, for example, by plates, particularly in the form of sheet metal components.

In yet another aspect, the entry of the tines into the guide tracks is improved due to the guide tracks being narrowed in the direction of an upper open end region of the guide tracks of the first guide assembly. In this way the tines are guided into the guide tracks of the first guide assembly. The entry into the guide track of the second guide assembly from the first guide assembly can be performed in a wide region, where, in turn, an interlocking of the tines or obstruction can be prevented.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a front view of a crop take-up assembly of an agricultural harvesting machine incorporating the principles of the present invention; and

FIG. 2 is a cross sectional view, generally taken along line 2-2 in FIG. 1, of a crop take-up assembly having a first and a second guide assembly.

### DESCRIPTION OF THE EMBODIMENTS

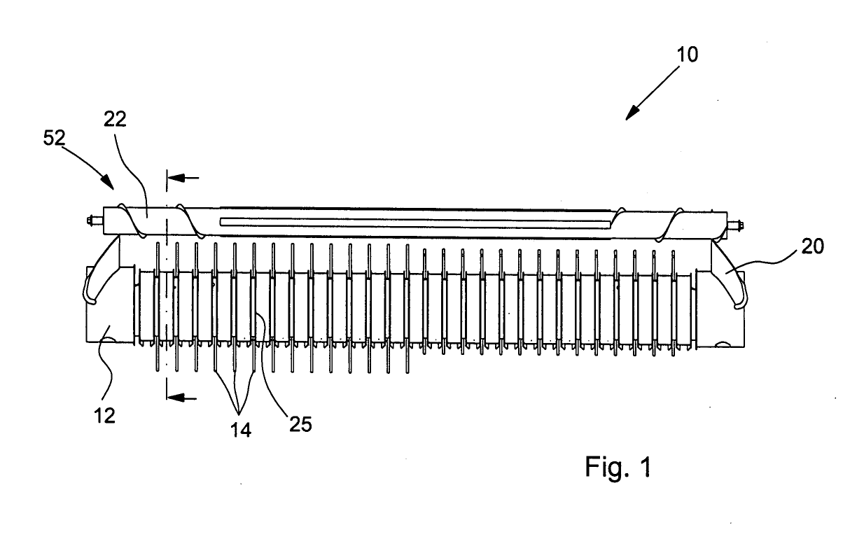

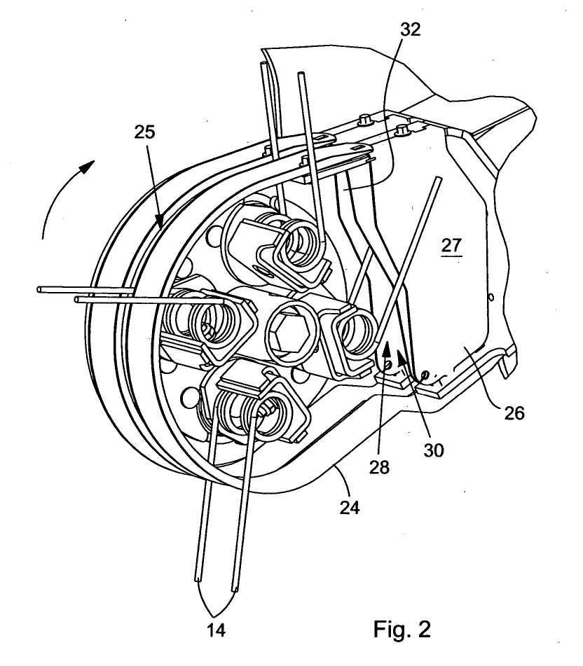

Referring to FIG. 1, a crop take-up assembly for an agricultural harvesting machine, such as a forage harvester, a combine or a baler, in accordance with the present invention is shown therein and generally designated at 10. The crop take-up assembly 10 includes a take-up rotor 12 with a plurality of tines 14 attached to the circumference thereof. The take-up rotor 12 and the tines 14 convey the crop in overshot manner. That is, and as shown in FIG. 2, the take-up rotor 12 rotates counter-clockwise. The tines 14 are rod-like members flexibly suspended from torsion or spiral springs 16. The take-up rotor 12 is rotatably supported by bearings within a take-up frame. Preferably the height of the take-up rotor 12 above the ground can be adjusted.

Sheet metal guide vanes 20 are provided at the side, toward both ends, of the take-up rotor 12 of the crop take-up assembly 10. The guide vanes 20 are intended to prevent the crop being taken up from falling sideways off the crop take-up assembly 10. Furthermore the crop take-up assembly 10 is positioned relative to a hold-down rotor 22, which is also rotatably supported on bearings on the take-up frame. The hold down rotor 22 rotates in the opposite direction from the crop take-up rotor 10. The hold-down rotor 22 is inclined at an angle to the direction of operation above the take-up assembly 10. In other words, the hold down rotor 22 is positioned upstream of the take-up rotor 12.

The hold-down rotor 22 is rotated by the harvested crop or it may be actively driven. The hold down rotor 22 insures uniform flow of the crop taken up and conveyed in the direction of a cutting assembly (not shown), and prevents, as far as possible, obstructions which could lead to an undesired interruption of the conveying of the crop and resulting loss of operating time. In particular, the hold-down rotor 22 provides assurance that the crop is not caught in the side regions of the crop take-up assembly 10.

Referring now to FIG. 2, shown therein is a cross section of the take-up rotor 12 where only one group of tines 14 is shown, along with the associated components. The tines 14 are surrounded by a first guide assembly 24 in an upper, forward and lower region. The first guide assembly 24 encloses the tines 14 and provides guide tracks, in the form of slots 25, in which the tines 14 can move or be rotated in a curved or circular path in order to convey harvested crop in an overshot manner during normal operation.

A second guide assembly 26 is provided in a region to the rear (in the direction of conveying) of the take-up rotor 12. The second guide assembly 26 is comprised of a plurality of individual guide surfaces or plates 28 that also define guide tracks 30. The guide surfaces 28 are oriented in such a way that the enclosed guide tracks 30 narrow in the direction of an upper, open end region 32 of the guide tracks 25 of the first guide assembly 24. The guide surfaces 28 are formed of individual plates 27 and may be in the form of sheet metal components. The plates 27 may be rigidly connected to one another or they may be separable. The plates 27 may also be mounted onto one or more carriers or to a frame. The plates could be secured in slots in such carriers or in a frame by an upsetting or other forming operation with an appropriate tool.

As shown, the take-up rotor 12 is driven in such a way that it can be reversed, when necessary, in a direction of conveying opposite to that described above, and counter-clockwise as viewed in FIG. 2. This would be necessary in the case of an obstruction.

The second guide assembly 26 contributes and improves operation by insuring that the tines 14 are guided during the reversal of the take-up rotor, such that they will readily enter the guide tracks 25 of the first guide assembly 24 without causing an obstruction and inhibiting rotation as a result thereof.

In accordance with the provisions of the patent statutes, the present invention has been described in what is considered to represent its preferred embodiment. However, it should be noted that the invention can be practiced otherwise than as specifically illustrated and described.

1. A crop take-up assembly comprising:
a rotatable take-up rotor having a plurality of tines supported thereon;
a first guide assembly enclosing the tines in an upper, forward and lower region, the first guide assembly defining a plurality of first guide tracks in which the tines are guided along a curved path; and
a second guide assembly enclosing the tines in a rear region, the second guide assembly guiding the tines into the guide tracks during a reversal of the take-up rotor.

2. A crop take-up assembly according to claim 1, wherein the second guide assembly defines a plurality of second guide tracks in which the tines are guided during a reversal of the take-up rotor.

3. A crop take-up assembly according to claim 2, wherein the second guide tracks are defined by guides surfaces of the second guide assembly.

4. A crop take-up assembly according to claim 3, wherein the guide surfaces are defined by sheet metal plates.

5. A crop take-up assembly according to claim 2, wherein the second guide tracks narrow in the direction of an upper, open end region of the guide tracks of the first guide assembly.

6. A crop take-up assembly according to claim 2, wherein the second guide tracks have a varying width.

7. A crop take-up assembly according to claim 6, wherein the first width is smaller than the second width.

8. A crop take-up assembly according to claim 6, wherein the second guide tracks smoothly taper from the second width to the first width.

9. A crop take-up assembly according to claim 2, wherein the second guide tracks have a first width in a portion adjacent to the first guide tracks and a second width in a portion located farther away from the first guide tracks.
